(19) United States
(12) Patent Application Publication
(10) Pub. No.: US 2020/0386365 A1
(43) Pub. Date: Dec. 10, 2020

(54) KNOCKDOWN BRACKETS FOR USE WITH FURNITURE

(71) Applicant: PALLISER FURNITURE, Winnipeg (CA)

(72) Inventor: David Main, Winnipeg (CA)

(21) Appl. No.: 16/432,494

(22) Filed: Jun. 5, 2019

(51) Int. Cl. F16M 13/02

(52) U.S. Cl. CPC F16M 13/02; F16M 2200/02

(57) ABSTRACT

Knockdown brackets for use with furniture. An example bracket assembly includes a bracket defining a groove to receive a tongue. A clip including a catch is carried at an end of the bracket. The catch is biased into a movement path of the tongue within the groove. A lever is carried by the clip. The lever is structured to move the catch to a released position in which the catch is out of the movement path of the tongue.

### FIELD OF THE DISCLOSURE

The present patent relates generally to knockdown brackets and, in particular, to knockdown brackets for use with furniture.

### BACKGROUND

Furniture may sometimes be manufactured and shipped as separate components and assembled by the customer or end user. In some known examples, the components are attached to one another using brackets. These brackets may be referred to as “knockdown brackets” or “KD brackets.” Some known knockdown brackets include locking clips that are biased toward a closed position and are structured to be received within an aperture a corresponding component of the furniture. To move the locking clip of known knockdown brackets from the closed position to the open position to enable disassembly, a screw driver is often necessary.

### SUMMARY

In accordance with a first example, a bracket assembly includes a bracket defining a groove to receive a tongue. A clip including a catch is carried at an end of the bracket. The catch is biased into a movement path of the tongue within the groove. A lever is carried by the clip. The lever is structured to move the catch to a released position in which the catch is out of the movement path of the tongue.

In accordance with a second example, a bracket assembly includes a bracket defining a groove to receive a tongue. A clip including a catch is carried at an end of the bracket. The catch is biased into a movement path of the tongue within the groove. A lever is carried by the clip. The lever is structured to retain the catch out of the movement path of the tongue to enable the tongue to be freely moved within the groove.

In accordance with a third example, furniture includes a seatback carrying first and second brackets or first or second tongues. A seat base carries the other of the first and second brackets or the first or second tongues. The first bracket is structured to receive the first tongue and the second bracket is structured to receive the second tongue to couple the seatback and the seat base together. The first bracket includes: a groove to receive the first tongue and a clip including a catch carried at an end of the first bracket. The catch is biased into a movement path of the first tongue within the groove. A lever is carried by the clip. The lever is structured to move and retain the catch in a released position in which the catch is positioned outside of the movement path of the first tongue to enable the first tongue to freely move within the groove.

In accordance with a fourth example, a bracket assembly includes a bracket defining a groove to receive a tongue. A clip including a catch is carried at an end of the bracket. The catch is biased into a movement path of the tongue within the groove. Means for moving the catch to, and retaining the catch in, a released position in which the catch is positioned outside of the movement path of the tongue to enable the tongue to freely move within the groove, is also disclosed herein.

In further accordance with the foregoing first, second, third and/or fourth examples, an apparatus and/or method may further include any one or more of the following:

In accordance with one example, the bracket is a knockdown bracket.

In accordance with another example, the lever defines a slot throughwhich the clip extends to enable the lever to be captured between the bracket and the clip.

In accordance with another example, the clip includes a U-shaped clip.

In accordance with another example, the catch includes a V-shaped protrusion.

In accordance with another example, to move the catch out of the movement path of the tongue, the lever is structured to be rotated against the bracket.

In accordance with another example, the lever is structured to retain the catch out of the movement path of the tongue.

In accordance with another example, after the lever has been rotated approximately 90° relative to a resting position of the lever, the clip is structured to urge the lever into engagement with the catch and the bracket to retain the lever in a retention position. The resting position is associated with the catch being within the movement path of the tongue. The retention position is associated with the catch being out of the movement path of the tongue.

In accordance with another example, the lever includes a handle to enable the lever to be rotated between a resting position and a retention position. In the resting position, the lever enables the catch to be within the movement path of the tongue. In the retention position, the lever enables the catch to be out of the movement path of the tongue.

In accordance with another example, the handle includes a curved handle to enable the handle to be grasped when the lever is in the resting position in which a portion of the lever lies substantially flush with a corresponding surface of the bracket.

In accordance with another example, the lever is structured to move the catch to the released position in which the catch is positioned outside of the movement path of the tongue.

In accordance with another example, after the lever has been rotated approximately 90° relative to a resting position of the lever, the clip is structured to urge the lever into engagement with the catch and the bracket to retain the lever in a retention position. The resting position is associated with the catch being within the movement path of the tongue. The retention position is associated with the catch being out of the movement path of the tongue.

In accordance with another example, the means for moving the catch to and retaining the catch in the released position includes a lever carried by the clip.

### BRIEF DESCRIPTION OF THE DRAWINGS

FIG. 1 illustrates an example bracket and an example tongue in accordance with the teachings of this disclosure that are structured to couple furniture components together.

FIG. 2 illustrates the tongue of FIG. 1 disposed within an example groove of the bracket of FIG. 1.

FIG. 3 illustrates an isometric view of an example catch of an example clip carried by the example bracket of FIG. 1 being retained in a released position by an example lever.

FIG. 4 illustrates a detailed isometric view of the catch of FIG. 3 being retained in the released position by the lever of FIG. 3.

FIG. 5 illustrates a detailed isometric view of the lever of FIG. 3 in a resting position in which a portion of the lever lies substantially flush with a corresponding surface of the bracket of FIG. 1.

FIG. 6 illustrates an isometric view of the bracket of FIG. 1 receiving the tongue of FIG. 1, the catch of FIG. 3 in a locked position and the lever of FIG. 3 in a resting position and being captured between the bracket and the clip of FIG. 3.

FIG. 7 illustrates a detailed isometric view of the catch of FIG. 3 being in the locked position and the lever of FIG. 3 being in the resting position.

FIG. 8 illustrates example furniture including a seatback and a seat base to which brackets and tongues are respectively coupled.

FIG. 9 illustrates a detailed view of one of the brackets coupled to a side of the seatback.

FIG. 10 illustrates the bracket carried by the seatback receiving the tongue carried by the seat base, where the catch of the bracket is in an unlocked position.

FIG. 11 illustrates the bracket carried by the seatback receiving the tongue carried by the seat base, where the catch of the bracket is in a locked position.

### DETAILED DESCRIPTION

Although the following text discloses a detailed description of example methods, apparatus and/or articles of manufacture, it should be understood that the legal scope of the property right is defined by the words of the claims set forth at the end of this patent. Accordingly, the following detailed description is to be construed as examples only and does not describe every possible example, as describing every possible example would be impractical, if not impossible. Numerous alternative examples could be implemented, using either current technology or technology developed after the filing date of this patent. It is envisioned that such alternative examples would still fall within the scope of the claims.

The inclusion of power headrests and power lumbar has increased the weight of some seatbacks. As the weight of the seatbacks increases, the spring force of locking clips used to attach the seatback to other components of the furniture also increases. The amount of force required to open the locking clip is directly related to the spring force (biasing force) of the locking clip. As a result, to open known locking clips used with furniture that are relatively strong, an individual typically lodges a flat-nosed screwdriver between the locking clip carried by the seatback and a tongue extending from the seat base. To uncouple the seat base and the seatback when the brackets and the tongues are disposed on both sides of the furniture, the individual moves the seatback away from the seat base while screwdrivers are lodged between the respective tongues and locking clips. Retaining the position of two screwdrivers between the locking clip and the tongue on either side of the furniture while moving the seatback away from the seat base is cumbersome and requires significant dexterity.

To alleviate the difficulty of retaining the locking clips in the open position, the examples disclosed herein relate to example knockdown brackets having levers that are structured to move the locking clips toward and secure the locking clips in the open position. In other words, the examples disclosed herein relate to levers carried by knockdown brackets that selectively lock and unlock the knockdown brackets. As a result, the disclosed examples easily enable seatbacks and seat bases to be secured relative to one another and also easily enable seatbacks and seat bases to be uncoupled for shipment and/or storage.

The knockdown brackets are structured to be carried by a first furniture component and to receive a tongue carried by a second furniture component. Some of these knockdown brackets include flanges that define a tapering groove having an opening at a first bracket end that receives the tongue. The locking clip includes a U-shaped bracket having a catch that is carried adjacent a second end of the knockdown bracket. The catch may be biased toward a movement path of the tongue defined within the knockdown bracket groove. The catch may be referred to as a V-shaped protrusion, a stepped protrusion or a locking tongue.

When the U-shaped bracket of the locking clip is coupled at the second end of the knockdown bracket, the U-shaped bracket is positioned about the second end such that the catch extends into the groove and the movement path of tongue. As a result and as disclosed, the catch is structured as a follower that follows an outer contour of the tongue as the tongue is inserted into the groove and impacts the catch. To secure the tongue and the knockdown bracket together via the locking clip, the catch extends into an aperture defined by the tongue when the tongue is fully inserted into the aperture.

To move the catch to the unlocked position, the locking clip carries an example lever that is captured between the locking clip and the knockdown bracket. To couple the lever to the locking clip, the lever includes an aperture throughwhich the locking clip extends. The aperture may be implemented as a slot.

To move the catch to the open position, an individual moves a first end of the lever implemented as a handle toward the second bracket end, thereby rotating an opposing end of the lever against the knockdown bracket and removing the catch from the movement path of the tongue. To retain the catch and the lever in the open position, the locking clip and the lever are structured to interact such that after the lever is rotated approximately or greater than 90° relative to the bracket and relative to a resting position of the lever, the biasing force of the locking clip encourages the lever to engage the catch, preventing further rotation of the lever and propping the catch in the open position. To move the catch back to the locking position, the individual rotates the handle against the biasing force of the locking clip toward the first end of the bracket. When the lever is positioned less than 90° relative to the resting position of the lever, the biasing force of the locking clip urges the catch, via the lever, into the locked position.

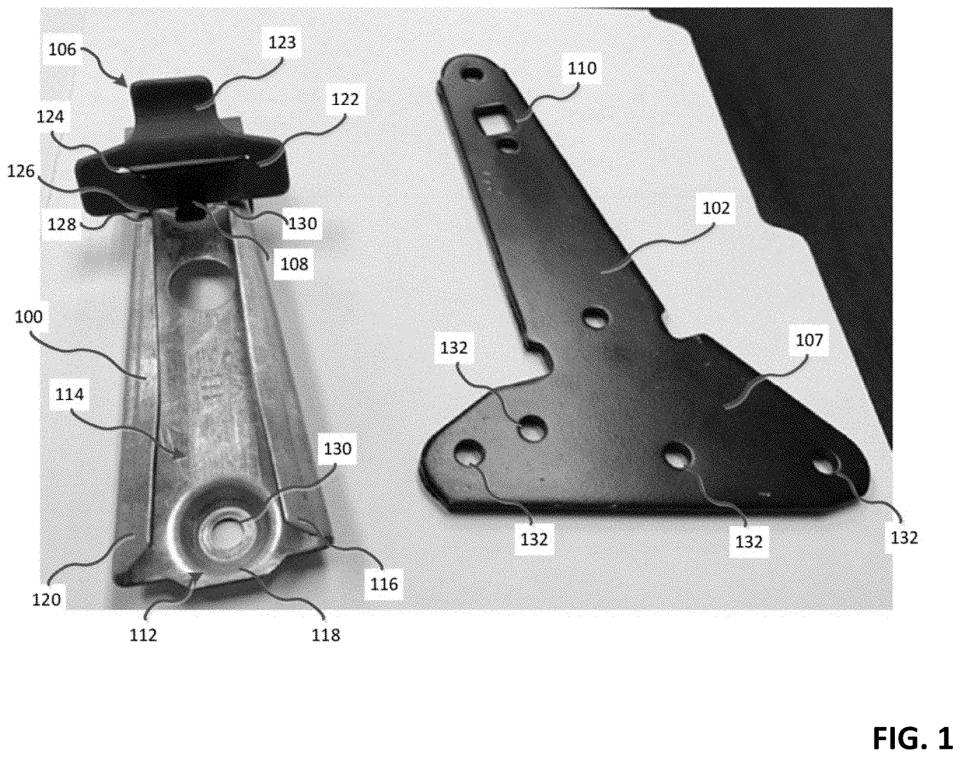

FIG. 1 illustrates an example bracket 100 and an example tongue 102 that are structured to couple furniture components together. The bracket 100 may be referred to as a knockdown bracket or a KD bracket and the furniture components may include seatbacks and seat bases.

To couple the bracket 100 and the tongue 102 together, an example clip 106 including an example catch 108 is shown being carried by the bracket 100. The clip 106 may be referred to as a locking clip and a base 107 is shown being coupled to the tongue 102. The catch 108 is structured to be received by an example aperture 110 of the tongue 102 when the tongue 102 is received within an example groove 112 of the bracket 100. Specifically, to enable the catch 108 to be received within the aperture 110, the catch 108 is biased into a movement path 114 within the groove 112. The groove 112 is shown being defined by first, second and third portions 116, 118, 120 of the bracket 100, where the first and third portions 116, 120 are shown being implemented by inward-facing flanges.

To enable the catch 108 to be easily moved from a locked position and a released position, the clip 106 carries an example lever 122 having an example handle 123. In the locked position, the catch 108 is positioned within the movement path 114 and, in the unlocked position, the catch 108 is positioned outside of the movement path 114.

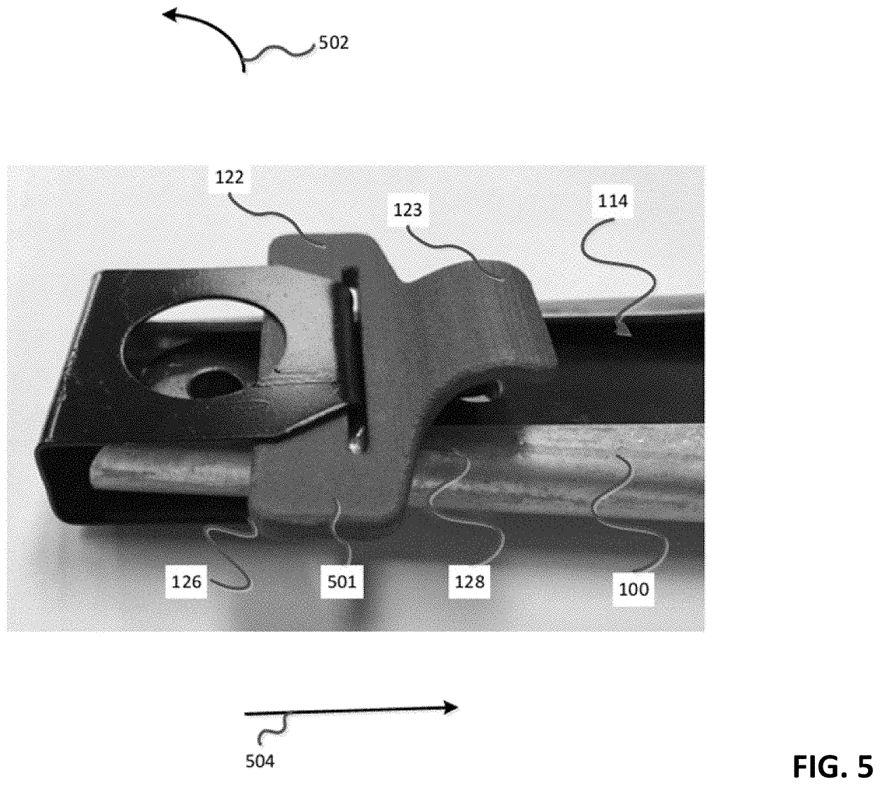

In FIG. 1, the lever 122 is shown in a retention position in which the catch 108 is removed or spaced from the movement path 114 and the clip 106 is shown urging the lever 122 into engagement with the catch 108 and the bracket 100 enabling the lever 122 to remain in the retention position. Specifically, by the clip 106 extending thorough an aperture 124 defined by the lever 122 and the clip 106 being biased toward the locked position, the clip 106 urges an end 126 of the lever 122 into engagement with a corresponding surface 128 of the bracket 100 and into engagement with the catch 108 after the lever 122 has been rotated approximately 90° relative to a resting position of the lever 122. As set forth herein, the phrase “approximately 90° means+/−50 of 90° or, more generally, is associated with an angle in which the clip 106 causes the lever 122 to move to the resting position or the retained positioned. In other words, after the lever 122 has been pivoted approximately 90° against the bracket 100 and relative to the resting position of the lever 122, an interaction between the clip 106, the catch 108, the lever 122 and the bracket 100 retains the catch 108 in a position spaced from the movement path 114 to enable the tongue 102 to freely move within the groove 112. The aperture 124 is shown being implemented as a slot. FIGS. 1, 2, 3 and 4 illustrate the lever 122 in the retention position that enables the catch 108 to be positioned out of the movement path 114. FIGS. 5, 6 and 7 illustrate the lever 122 in the resting position that enables the catch 108 to be positioned within the movement path 114.

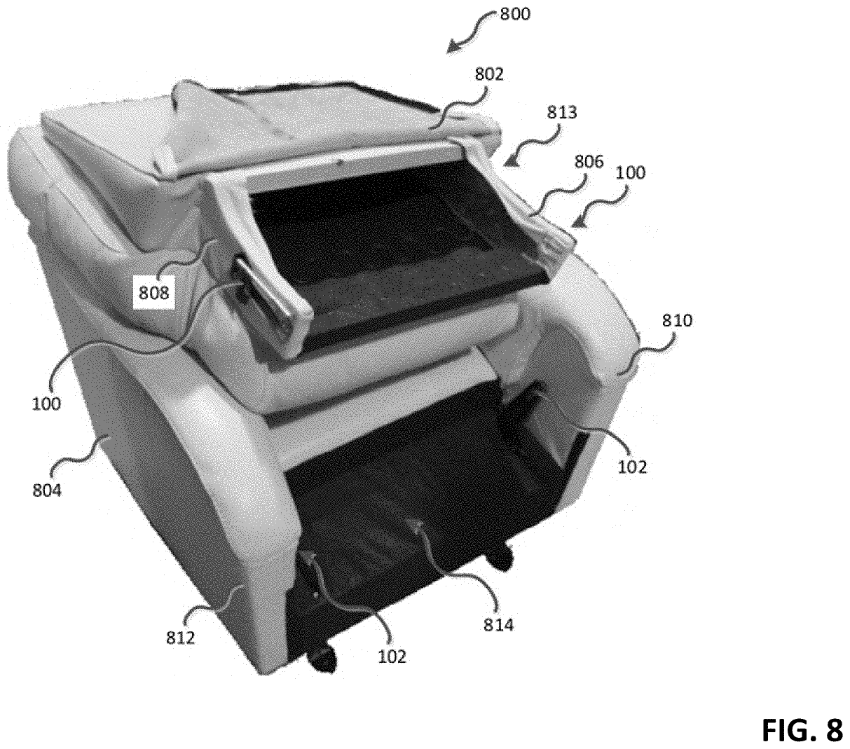

To enable the bracket 100 to be coupled to a first furniture component, the bracket 100 defines apertures 130 that receive fasteners. Similarly, to enable the tongue 102 to be coupled to a second furniture component, the base 104 of the tongue 102 defines apertures 132 that receive fasteners. In some examples, opposing sides of the first furniture component carries two of the brackets that are positioned to receive tongues carried by opposing sides of the second furniture component. The first furniture component can be one of a seatback or a seat base and the second furniture component can be the other of the seatback or the seat base. (See, FIGS. 8-11).

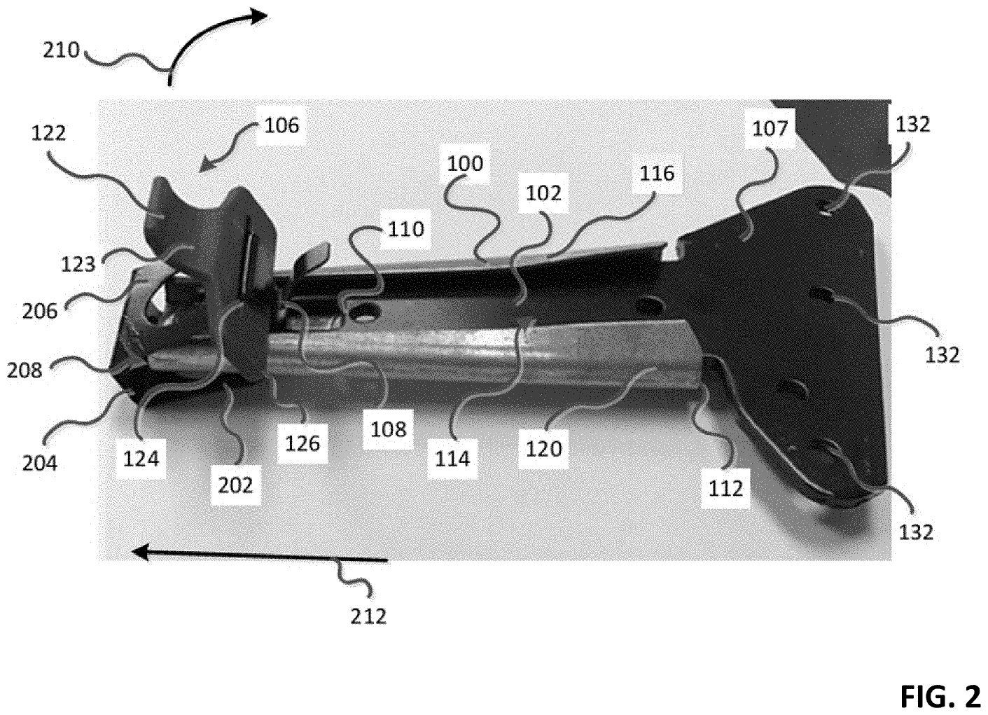

FIG. 2 illustrates the tongue 102 disposed within the groove 112 of the bracket 100. In FIG. 2, the clip 106 is shown being implemented as a U-Shaped clip and the catch 108 is shown being implemented as a V-shaped protrusion. To couple the clip 106 and the bracket 100 and to enable the catch 108 to be biased to extend into the movement path 114, a first leg 202 of the clip 106 is coupled to the bracket 100 via, a fastener such as a rivet, such that the first leg 202, a second leg 204 and a third leg 206 of the clip 106 are positioned about an end 208 of the bracket 100.

In this example, when the lever 122 is rotated approximately or greater than 90° relative to the resting position of the lever 122, the relative engagement between the clip 106, surfaces of the lever 122 defining the aperture 124 and the catch 108, prop the catch 108 out of the movement path 114, as shown. To position the catch 108 within the movement path 114 and the aperture 110 of the tongue 102 to secure the tongue 102 relative to the bracket 100, the handle 123 is rotated in a direction generally represented by arrow 210 while the end 126 of the lever 122 is translated relative to the bracket 100 in a direction generally represented by arrow 212. Conversely, to remove the catch 108 from within the movement path 114 and the aperture 110 to enable the tongue 102 to be uncoupled from the bracket 100, the handle 123 is rotated in a direction generally opposite that represented by arrow 210 while the end 126 of the lever 122 is translated relative to the bracket 100 in a direction generally opposite that represented by arrow 212.

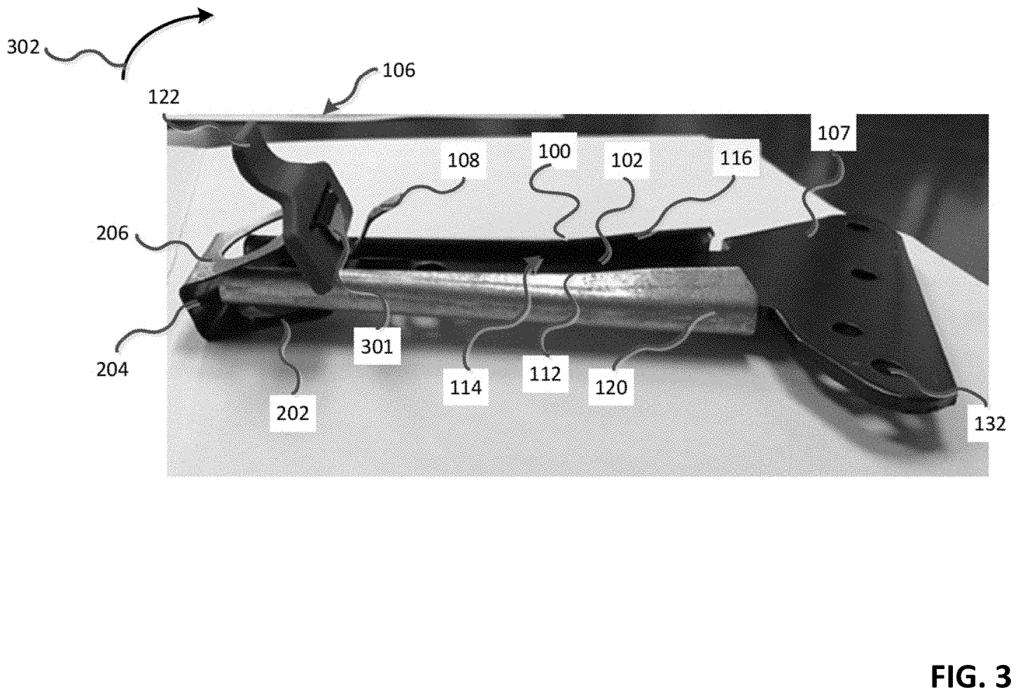

FIG. 3 illustrates another isometric view of the bracket 100 receiving the tongue 102 in the groove 112 and the catch 108 being retained in the released position by the example lever 122. In the released position, the lever 122 engages a leg 301 of the catch 108 to retain the relative position of the lever 122. As also shown, the coupling between the first leg 202 of the clip 106 and the bracket 100 causes the clip 106 to be biased in a direction generally indicated by arrow 302.

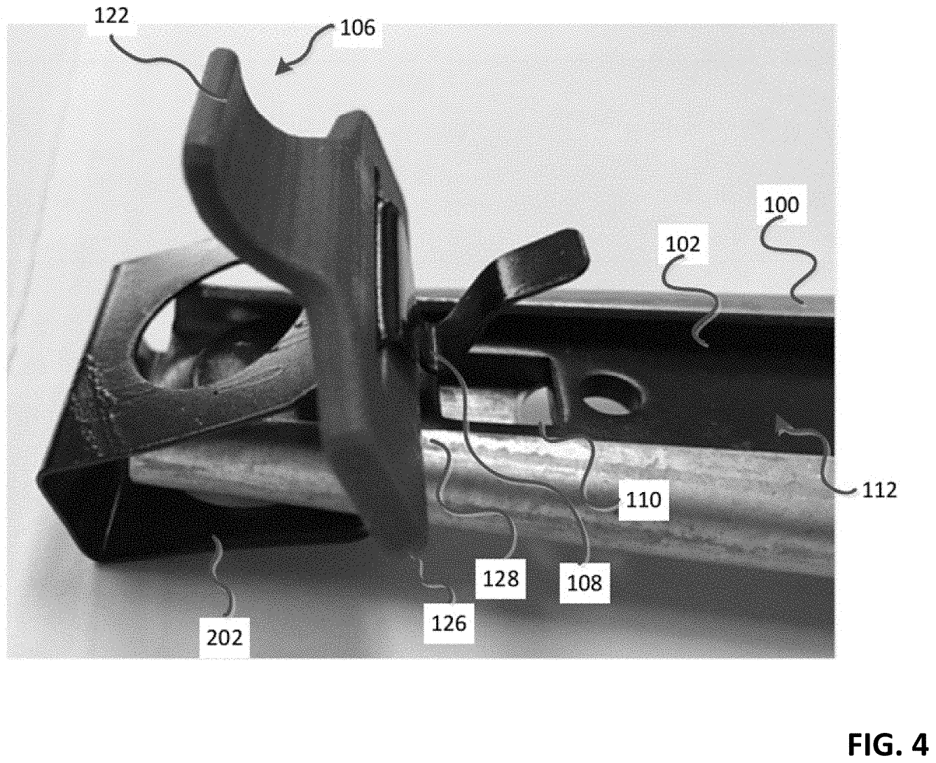

FIG. 4 illustrates a detailed view of the bracket 100 receiving the tongue 102 in the groove 112 and the catch 108 being retained in the released position by the example lever 122.

FIG. 5 illustrates the lever 122 in the resting position in which a portion 501 of the lever 122 lies substantially flush with the corresponding surface 128 of the bracket 100. As set forth herein, the phrase “substantially flush” accounts for manufacturing tolerances. To enable the handle 123 to be grasped when the lever 122 is in the resting position, the example of FIG. 5 illustrates the handle 123 being implemented as a curved handle that extends from the portion 501 of the lever 122. To move the catch 108 to the released position to enable the tongue 102 to be uncoupled from the bracket 100, the handle 123 is rotated in a direction generally represented by arrow 502 while the end 126 of the lever 122 is translated relative to the bracket 100 in a direction generally represented by arrow 504.

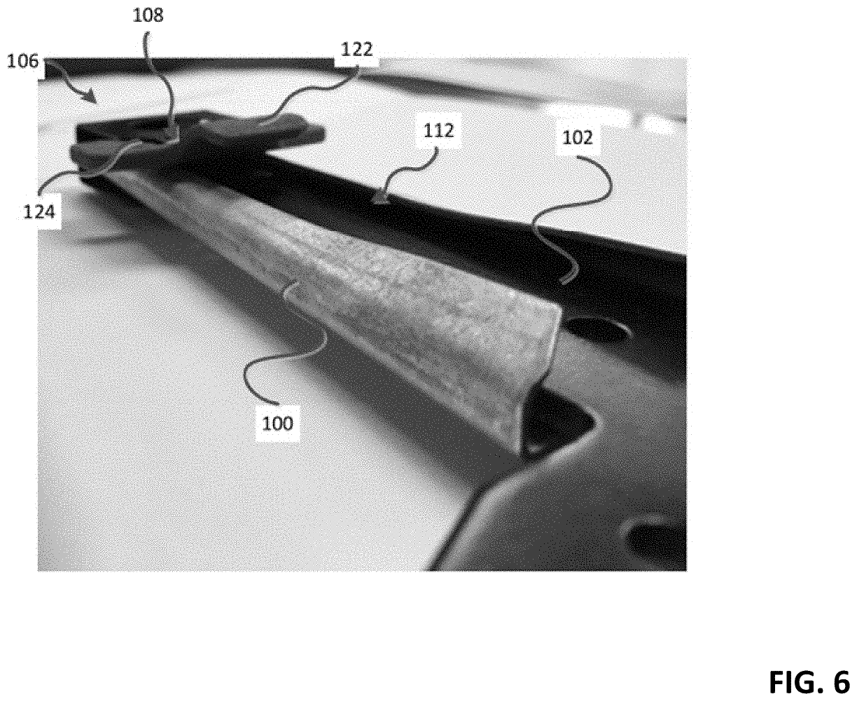

FIG. 6 illustrates another isometric view of the bracket 100 receiving the tongue 102 in the groove 112, the catch 108 being in the locked position and the lever 122 being captured between the bracket 100 and the clip 106 based on the coupling between the lever 122 and the clip 106. As shown, the clip 106 extends through the aperture 124 of the lever 122 implemented as a slot.

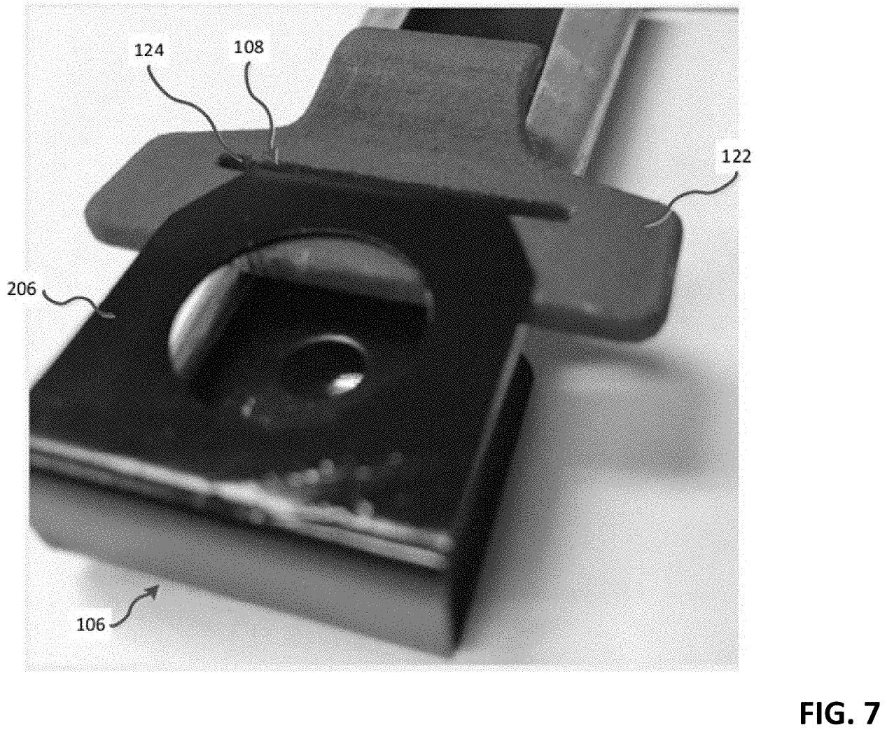

FIG. 7 illustrates a detailed isometric view of the catch 108 being in the locked position, the lever 122 being in the resting position and the clip 106 extending through the aperture 124 of the lever 122.

FIG. 8 illustrates example furniture 800 including a seatback 802 and a seat base 804, where the seatback 802 is resting on top of the seat base 804 in a shipping configuration. In this example, two of the brackets 100 are coupled to sides 806, 808 of the seatback 802 via fasteners and two of the tongues 102 are coupled adjacent sides 810, 812 of the seat base 804 via fasteners. As shown, a portion 813 of the seatback 802 carrying the brackets 100 is sized to be positioned within a receptacle 814 of the seat base 804 in which the tongues 102 are housed.

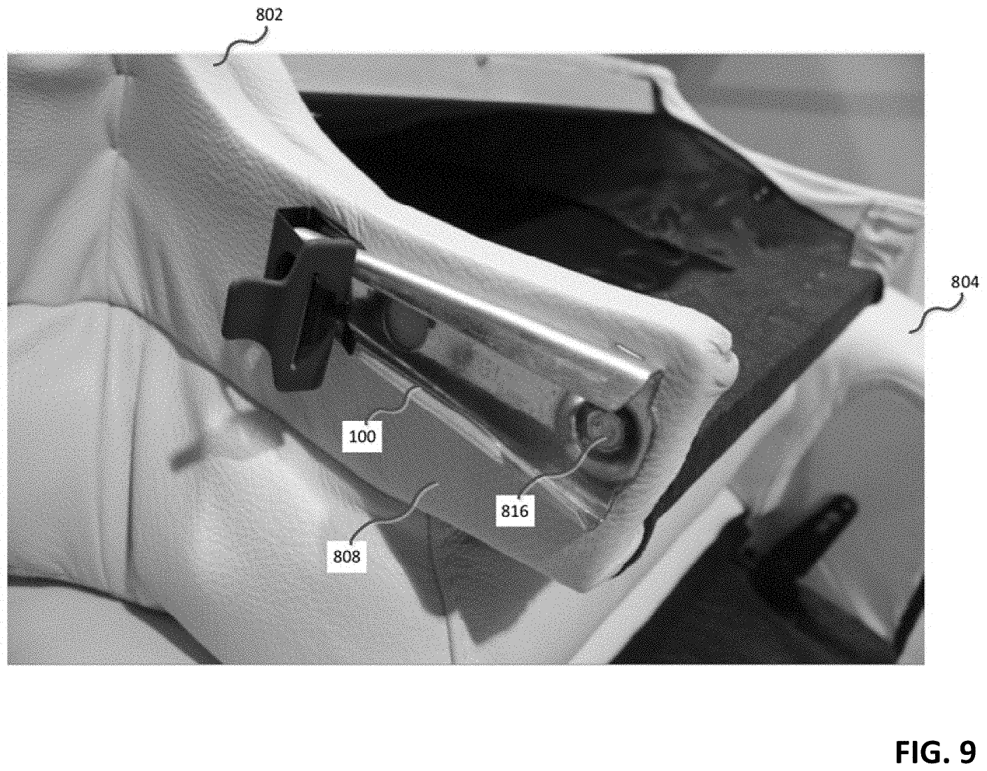

FIG. 9 illustrates a detailed view of the bracket 100 coupled to the side 808 of the seatback 802 via fasteners 816.

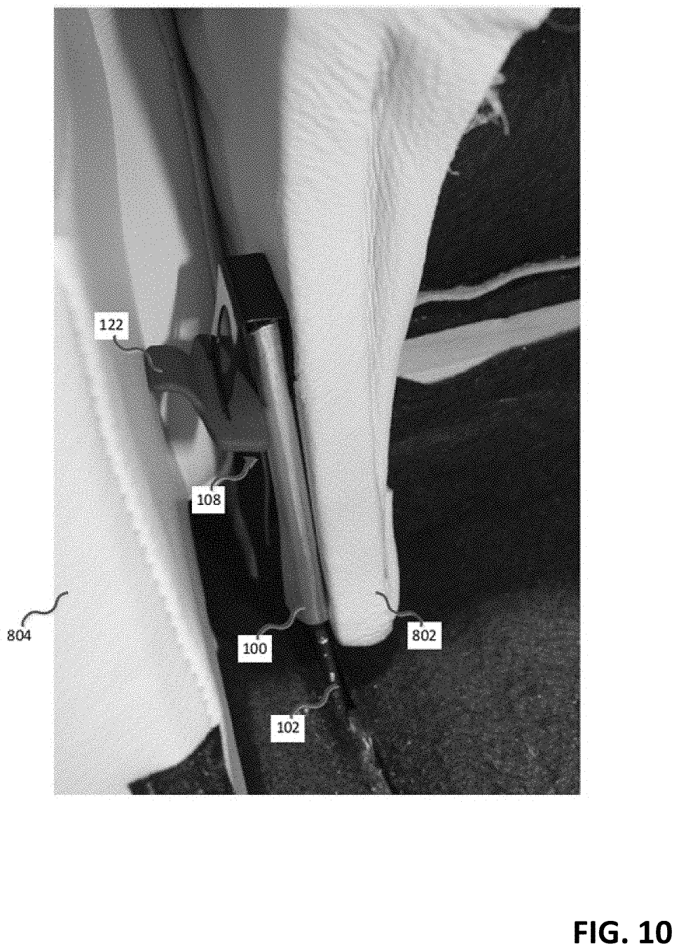

FIG. 10 illustrates the bracket 100 carried by the seatback 802 receiving the tongue 102 carried by the seat base 804. As shown, the lever 122 is retaining the catch 108 in the released position.

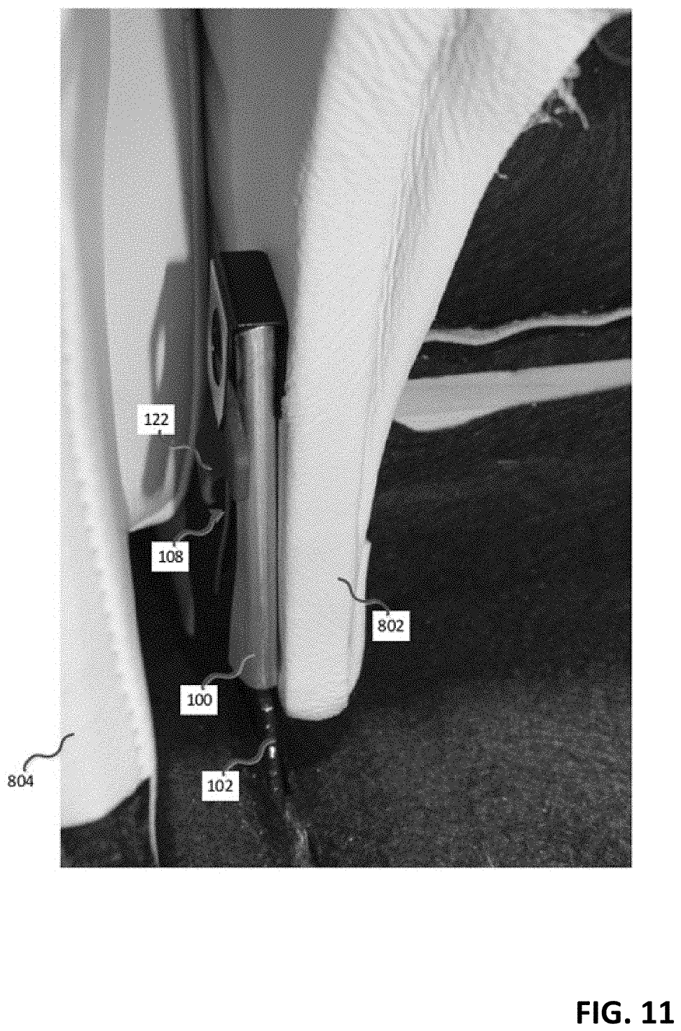

FIG. 11 illustrates the bracket 100 receiving the tongue 102 and the lever 122 in the resting position to couple the seatback 802 and the seat base 804 together. While FIG. 11 shows one of the sides 808, 812 of the seatback 802 and the seat base 804 being coupled, the other one of the sides 806, 810 may be similarly coupled.

From the foregoing, it will be appreciated that the above disclosed apparatus, methods and articles of manufacture enable catches of knockdown brackets to be easily pivoted between a locked and unlocked position. Furthermore, the examples disclosed herein enable catches of knockdown brackets to be easily retained in the unlocked position. As a result, some of the difficulties associated with disassembling known knockdown furniture are removed or at least decreased. Specifically, instead of retaining clips of these known knockdown brackets on both sides of a piece of furniture in the unlocked position using separate hand tools while moving the seatback away from the seat base, the examples disclosed herein enable the clips to be moved and retained in the open position. As such, an individual disassembling furniture including the disclosed knockdown brackets can move the seatback away from the seat base without the use of additional tools and without performing multiple tasks at once because the example knockdown brackets can be moved to and retained in the open position without additional tools.

Further, while several examples have been disclosed herein, any features from any examples may be combined with or replaced by other features from other examples. Moreover, while several examples have been disclosed herein, changes may be made to the disclosed examples within departing from the scope of the claims.

What is claimed is:

1. A bracket assembly comprising:
a bracket defining a groove to receive a tongue;
a clip including a catch carried at an end of the bracket, the catch being biased into a movement path of the tongue within the groove; and
a lever carried by the clip, the lever structured to move the catch to a released position in which the catch is out of the movement path of the tongue.

2. The bracket assembly of claim 1, wherein the bracket is a knockdown bracket.

3. The bracket assembly of claim 1, wherein the lever defines a slot throughwhich the clip extends to enable the lever to be captured between the bracket and the clip.

4. The bracket assembly of claim 1, wherein the clip includes a U-shaped clip.

5. The bracket assembly of claim 1, wherein the catch includes a V-shaped protrusion.

6. The bracket assembly of claim 1, wherein to move the catch out of the movement path of the tongue, the lever is structured to be rotated against the bracket.

7. The bracket assembly of claim 1, wherein the lever is structured to retain the catch out of the movement path of the tongue.

8. The bracket assembly of claim 7, wherein after the lever has been rotated approximately 90° relative to a resting position of the lever, the clip is structured to urge the lever into engagement with the catch and the bracket to retain the lever in a retention position, the resting position being associated with the catch being within the movement path of the tongue, the retention position being associated with the catch being out of the movement path of the tongue.

9. The bracket assembly of claim 1, wherein the lever includes a handle to enable the lever to be rotated between a resting position and a retention position, in the resting position, the lever enabling the catch to be within the movement path of the tongue, in the retention position, the lever enabling the catch to be out of the movement path of the tongue.

10. The bracket assembly of claim 9, wherein the handle includes a curved handle to enable the handle to be grasped when the lever is in the resting position in which a portion of the lever lies substantially flush with a corresponding surface of the bracket.

11. An bracket assembly, comprising:
a bracket defining a groove to receive a tongue;
a clip including a catch carried at an end of the bracket, the catch being biased into a movement path of the tongue within the groove; and
a lever carried by the clip, the lever structured to retain the catch out of the movement path of the tongue to enable the tongue to be freely moved within the groove.

12. The bracket assembly of claim 11, wherein the bracket is a knockdown bracket.

13. The bracket assembly of claim 11, wherein the lever defines a slot throughwhich the clip extends to enable the lever to be captured between the bracket and the clip.

14. The bracket assembly of claim 11, wherein the clip includes a U-shaped clip.

15. The bracket assembly of claim 11, wherein the catch includes a V-shaped protrusion.

16. The bracket assembly of claim 11, wherein the lever is structured to move the catch to the released position in which the catch is positioned outside of the movement path of the tongue.

17. The bracket assembly of claim 11, wherein after the lever has been rotated approximately 90° relative to a resting position of the lever, the clip is structured to urge the lever into engagement with the catch and the bracket to retain the lever in a retention position, the resting position associated with the catch being within the movement path of the tongue, the retention position associated with the catch being out of the movement path of the tongue.

18. The bracket assembly of claim 11, wherein the lever includes a handle to enable the lever to be rotated between a resting position and a retention position, in the resting position, the lever enabling the catch to be within the movement path of the tongue, in the retention position, the lever enabling the catch to be out of the movement path of the tongue.

19. The bracket assembly of claim 18, wherein the handle includes a curved handle to enable the handle to be grasped when the lever is in the resting position in which a portion of the lever lies substantially flush with a corresponding surface of the bracket.

20. Furniture, comprising:
a seatback carrying first and second brackets or first or second tongues;
a seat base carrying the other of the first and second brackets or the first or second tongues, the first bracket structured to receive the first tongue and the second bracket structured to receive the second tongue to couple the seatback and the seat base together, wherein the first bracket includes:
a groove to receive the first tongue;
a clip including a catch carried at an end of the first bracket, the catch being biased into a movement path of the first tongue within the groove; and
a lever carried by the clip, the lever structured to move and retain the catch in a released position in which the catch is out of the movement path of the first tongue to enable the first tongue to freely move within the groove.

21. A bracket assembly, comprising:
a bracket defining a groove to receive a tongue;
a clip including a catch carried at an end of the bracket, the catch being biased into a movement path of the tongue within the groove; and
means for moving the catch to, and retaining the catch in, a released position in which the catch is positioned outside of the movement path of the tongue to enable the tongue to freely move within the groove.

22. The bracket assembly of claim 21, wherein the means for moving the catch to and retaining the catch in the released position includes a lever carried by the clip.
